(19) United States
(12) Patent Application Publication
(10) Pub. No.: US 2018/0324616 A1
(43) Pub. Date: Nov. 8, 2018

(54) GENERATING LOCATION DATA WHILE CONSERVING RESOURCES

(71) Applicant: QUALCOMM Incorporated, San Diego, CA (US)

(72) Inventors: Muthukumaran DHANAPAL, San Diego, CA (US); Sai Pradeep VENKATRAMAN, Santa Clara, CA (US); Parthasarathy KRISHNAMOORTHY, San Diego, CA (US); Shravan Kumar RAGHUNATHAN, San Diego, CA (US); Akash KUMAR, Hyderabad (IN); Ankita, Hyderabad (IN); Hargovind Prasad BANSAL, Hyderabad (IN); Vasanth Kumar RAMKUMAR, San Diego, CA (US)

(21) Appl. No.: 15/586,251

(22) Filed: May 3, 2017

(51) Int. Cl. H04W 24/10; H04B 7/185; H04W 4/02; G01S 19/48; G01S 19/23

(52) U.S. Cl. CPC H04W 24/10; H04B 7/1851; G01S 19/23; G01S 19/48; H04W 4/023

(57) ABSTRACT

The disclosure relates to position sensors. An apparatus in accordance with aspects of the disclosure, the apparatus includes a wireless transceiver configured to transmit and receive wireless signals, a SPS receiver configured to receive SPS signals, memory, and a processor. The processor/memory may be configured to generate SPS-based location data using the SPS receiver in response to receipt of a MDT measurement request, determine whether the SPS-based location data is accurate or not accurate, in response to a determination that the SPS-based location data is not accurate, generate network-based location data using the wireless transceiver and include the network-based location data in an MDT report, in response to a determination that the SPS-based location data is accurate, include the SPS-based location data in the MDT report, and transmit the MDT report, wherein the MDT report includes one or both of the SPS-based location data and/or the network-based location data.

### FIELD OF DISCLOSURE

Various embodiments described herein generally relate to position sensors, and more particularly to generation of location data while conserving resources.

### BACKGROUND

Communications networks offer increasingly sophisticated capabilities associated with the motion and/or position location sensing of a mobile device. New software applications, such as, for example, those related to personal productivity, collaborative communications, social networking, and/or data acquisition, may utilize motion and/or position sensors to provide new features and services to consumers. Moreover, some regulatory requirements of various jurisdictions may require a network operator to report the location of a mobile device when the mobile device places a call to an emergency service, such as a “911” call in the United States.

Such motion and/or position determination capabilities have conventionally been provided using Satellite Positioning Systems (SPS). SPS wireless technologies which may include, for example, the Global Positioning System (GPS) and/or a Global Navigation Satellite System (GNSS). A mobile device supporting SPS may obtain positioning signals as wireless transmissions received from one or more satellites equipped with transmitting devices. The positioning signal may be used to generate SPS-based location data.

The mobile device may also be associated with one or more terrestrial networks. For example, the one or more terrestrial networks may conform to specifications such as Long-Term Evolution (LTE) (provided by the Third Generation Partnership Project (3GPP)), Ultra Mobile Broadband (UMB) and Evolution Data Optimized (EV-DO) (provided by the Third Generation Partnership Project 2 (3GPP2)), 802.11 (provided by the Institute of Electrical and Electronics Engineers (IEEE)), etc. As terrestrial networks become more sophisticated, they may use the SPS-based location data generated by the mobile device to better serve the mobile device. For example, the terrestrial network may use the generated SPS-based location data to estimate a geographic position and heading of the mobile device, and allocate resources or prepare for a handover based on the estimate.

For the foregoing reasons, the terrestrial network may occasionally request a position report from the mobile device. However, the reporting tasks performed by the mobile device can be costly. For example, the mobile device may consume large amounts of resources in a scenario where the SPS-based location data can not be obtained readily or accurately. Accordingly, new techniques are needed for conserving resources when generating location data.

### SUMMARY

The following summary is an overview provided solely to aid in the description of various aspects of the disclosure and is provided solely for illustration of the aspects and not limitation thereof.

In one example, an apparatus is disclosed. The apparatus, the apparatus may include, for example, a wireless transceiver configured to transmit and receive wireless signals, a satellite positioning service (SPS) receiver configured to receive SPS signals, memory, and a processor coupled to the wireless transceiver, the SPS receiver, and the memory. One or more of the processor and the memory may be configured to generate SPS-based location data using the SPS receiver in response to receipt of a minimization of drive test (MDT) measurement request, determine whether the SPS-based location data is accurate or not accurate, in response to a determination that the SPS-based location data is not accurate, generate network-based location data using the wireless transceiver and include the network-based location data in an MDT report, in response to a determination that the SPS-based location data is accurate, include the SPS-based location data in the MDT report, and transmit the MDT report, wherein the MDT report includes one or both of the SPS-based location data and/or the network-based location data.

In another example, a method is disclosed. The method may include, for example, generating SPS-based location data using the SPS receiver in response to receipt of a minimization of drive test (MDT) measurement request, determining that the SPS-based location data is not accurate, in response to the determination that the SPS-based location data is not accurate, generating network-based location data using the wireless transceiver and including the network-based location data in an MDT report, in response to a determination that the SPS-based location data is accurate, including the SPS-based location data in the MDT report, and transmitting the MDT report, wherein the MDT report includes one or both of the SPS-based location data and/or the network-based location data.

In yet another example, an apparatus is disclosed. The apparatus, the apparatus may include, for example, a wireless transceiver configured to transmit and receive wireless signals, a satellite positioning service (SPS) receiver configured to receive SPS signals, memory, and a processor coupled to the wireless transceiver, the SPS receiver, and the memory. One or more of the processor and the memory is configured to generate first SPS-based location data using received SPS signals, determine that the first SPS-based location data is not accurate, in response to the determination that the first SPS-based location data is not accurate, record accuracy factor data relating to one or more accuracy factors, determine whether to generate second SPS-based location data based on whether the recorded accuracy factor data indicates that the second SPS-based location data will be accurate, and in response to a determination to generate second SPS-based location data, generate the second SPS-based location data.

In yet another example, a method is disclosed. The method may include, for example, generating first SPS-based location data using a satellite positioning service (SPS), determining that the first SPS-based location data is not accurate, in response to the determination that the first SPS-based location data is not accurate, recording accuracy factor data relating to one or more accuracy factors, determining whether to generate second SPS-based location data based on whether the recorded accuracy factor data indicates that the second SPS-based location data will be accurate, in response to a determination to generate second SPS-based location data, generating the second SPS-based location data.

### BRIEF DESCRIPTION OF THE DRAWINGS

The accompanying drawings are presented to aid in the description of various aspects of the disclosure and are provided solely for illustration of the aspects and not limitation thereof.

FIG. 1 generally illustrates a position sensing environment in accordance with aspects of the disclosure.

FIG. 2 generally illustrates a mobile device having position sensing capabilities.

FIG. 3 generally illustrates a detail of an SPS receiver depicted in FIG. 2.

FIG. 4 generally illustrates a method in accordance with aspects of the disclosure.

FIG. 5 generally illustrates another method in accordance with aspects of the disclosure.

FIG. 6 generally illustrates another method in accordance with aspects of the disclosure.

FIG. 7 generally illustrates another method in accordance with aspects of the disclosure.

### DETAILED DESCRIPTION

Various aspects are disclosed in the following description and related drawings. Alternate aspects may be devised without departing from the scope of the disclosure. Additionally, well-known elements of the disclosure will not be described in detail or will be omitted so as not to obscure the relevant details of the disclosure. The words “exemplary” and/or “example” are used herein to mean “serving as an example, instance, or illustration”. Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

The terminology used herein is for the purpose of describing particular embodiments only and not to limit any embodiments disclosed herein. As used herein, the singular forms “a”, “an” and “the” are intended to include the plural forms as well, unless the context clearly indicates otherwise. It will be further understood that the terms “comprises”, “comprising”, “includes” and/or “including”, when used herein, specify the presence of stated features, integers, steps, operations, elements, and/or components, but do not preclude the presence or addition of one or more other features, integers, steps, operations, elements, components, and/or groups thereof.

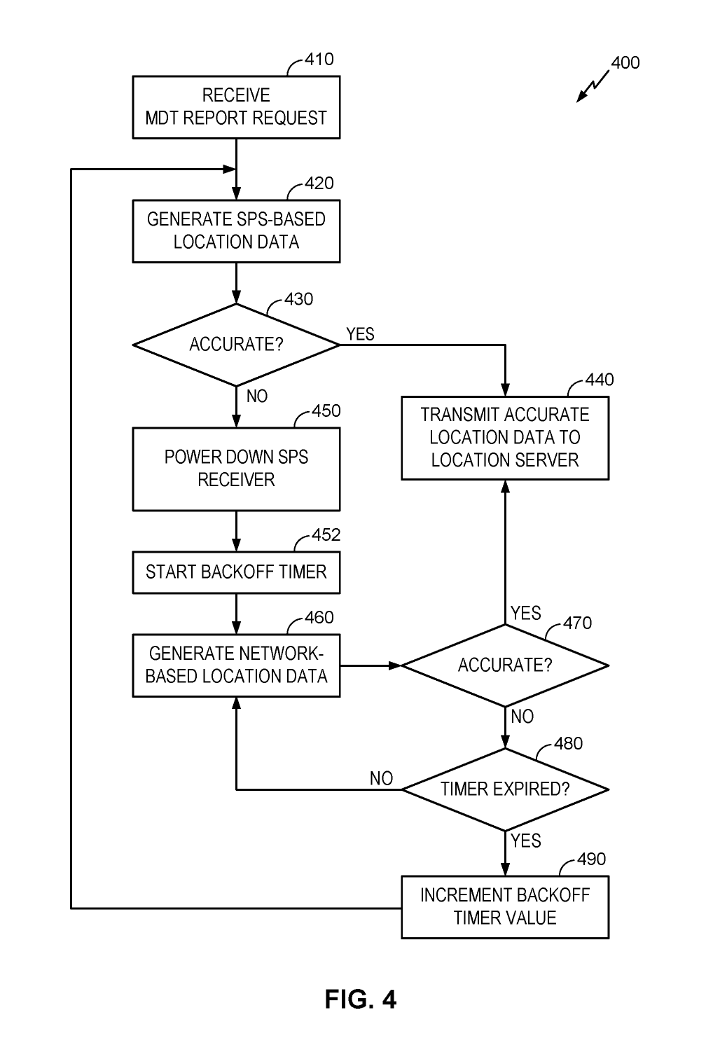

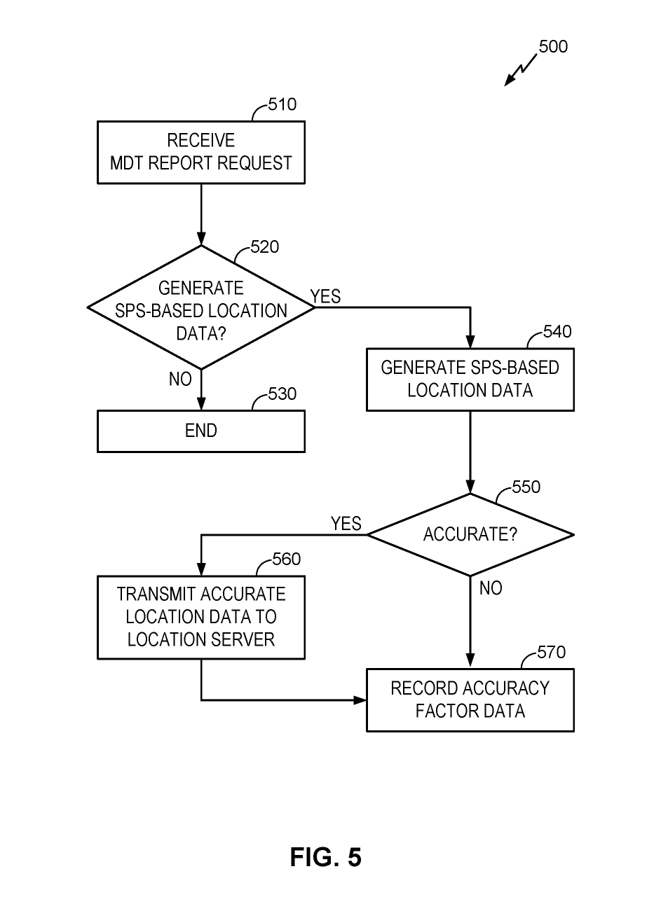

Further, many aspects are described in terms of sequences of actions to be performed by, for example, elements of a computing device. It will be recognized that various actions described herein can be performed by specific circuits (e.g., an application specific integrated circuit (ASIC)), by program instructions being executed by one or more processors, or by a combination of both. Additionally, these sequence of actions described herein can be considered to be embodied entirely within any form of non-transitory computer-readable storage medium having stored therein a corresponding set of computer instructions that upon execution would cause or instruct an associated processor to perform the functionality described herein, such as, for example, the functionality associated with any of FIGS. 4, 5, and/or 6. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

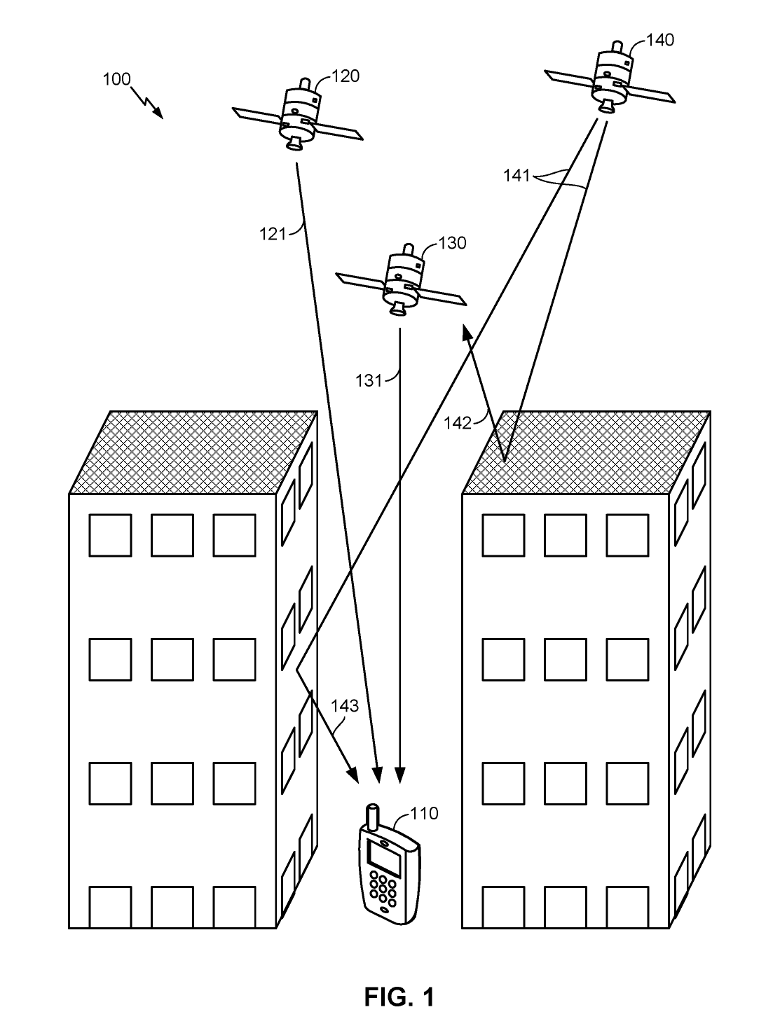

FIG. 1 generally illustrates a position sensing environment 100 in accordance with aspects of the disclosure. The position sensing environment 100 may include a mobile device 110. The mobile device 110 may be configured to determine a position of the mobile device 110 based, at least in part, on positioning signals received within the position sensing environment 100. Although the mobile device 110 is depicted as a mobile telephone, it will be understood that the mobile device 110 may be a music player, a video player, an entertainment unit, a navigation device, a communications device, a mobile device, a mobile phone, a smartphone, a personal digital assistant, a fixed location terminal, a tablet computer, a computer, a wearable device, an Internet of things (IoT) device, a laptop computer, a server, a device in a automotive vehicle, and/or any other device with a need for position sensing capability.

As depicted in FIG. 1, the position sensing environment 100 includes a plurality of transmitting devices 120, 130, 140. The transmitting device 120 may transmit a positioning signal 121, the transmitting device 130 may transmit a positioning signal 131, and the transmitting device 140 may transmit a positioning signal 141. In the position sensing environment 100 depicted in FIG. 1, each of the transmitting devices 120, 130, 140 may be associated with a particular satellite vehicle, and the plurality of satellite vehicles may be part of a satellite positioning system (SPS). However, it will be understood that the mobile device 110 may be configured to receive positioning signals analogous to the positioning signals 121, 131, 141 from any suitable signal source.

In a SPS, a system of transmitting devices (depicted as transmitting devices 120, 130, 140) enable devices such as the mobile device 110 to sense a position on or above the earth based, at least in part, on signals received from transmitting devices analogous to the transmitting devices 120, 130, 140. The transmitting devices 120, 130, 140 may transmit a signal that includes a code, for example, a repeating pseudo-random noise (PRN) code. The transmitting devices 120, 130, 140 may be located on ground-based control stations, user equipment and/or space vehicles. In some implementations, the transmitting devices 120, 130, 140 may be located on Earth-orbiting satellite vehicles (SVs). For example, a SV in a constellation of a Global Navigation Satellite System (GNSS) such as Global Positioning System (GPS), Galileo, Glonass or Compass may transmit a signal marked with a particular code that is distinguishable from codes transmitted by other SVs in the constellation (e.g., using different codes for each satellite as in GPS or using the same code on different frequencies as in Glonass). In accordance with certain aspects, the techniques presented herein are not restricted to global systems (e.g., GNSS) for SPS. For example, the techniques provided herein may be applied to or otherwise enabled for use in various regional systems, such as, e.g., Quasi-Zenith Satellite System (QZSS) over Japan, Indian Regional Navigational Satellite System (IRNSS) over India, Beidou over China, etc., and/or various augmentation systems (e.g., an Satellite Based Augmentation System (SBAS)) that may be associated with or otherwise enabled for use with one or more global and/or regional navigation satellite systems. By way of example but not limitation, an SBAS may include an augmentation system(s) that provides integrity information, differential corrections, etc., such as, e.g., Wide Area Augmentation System (WAAS), European Geostationary Navigation Overlay Service (EGNOS), Multi-functional Satellite Augmentation System (MSAS), GPS Aided Geo Augmented Navigation or GPS and Geo Augmented Navigation system (GAGAN), and/or the like. Thus, as used herein an SPS may include any combination of one or more global and/or regional navigation satellite systems and/or augmentation systems, and SPS signals may include SPS, SPS-like, and/or other positioning signals associated with such one or more SPS.

The position sensing environment 100 depicted in FIG. 1 shows an example of a particular scenario in which methods for determining position based on positioning signals (for example, positioning signals associated with an SPS) may be inadequate. Consider, for example, a scenario in which the mobile device 110 must receive each of the plurality of positioning signals 121, 131, 141 in order to quickly and accurately determine the position of the mobile device 110. In the scenario depicted in FIG. 1, tall structures block one or more of the positioning signals 121, 131, 141. The positioning signal 121 may facilitate position sensing because there is a direct line of sight between the mobile device 110 and the transmitting device 120. Likewise, the positioning signal 131 may facilitate position sensing because there is a direct line of sight between the mobile device 110 and the transmitting device 130. However, because there are intervening structures, the positioning signal 141 may not facilitate position sensing by the mobile device 110.

FIG. 1 depicts two intervening structures, both of which are depicted as tall buildings. However, it will be understood that any intervening structure, natural or man-made, may affect transmission of the positioning signals 121, 131, 141. In this scenario, the positioning signal 141 is blocked by one or more intervening structures, resulting in a blocked positioning signal 142. Because the positioning signal 141 never reaches the mobile device 110, it may not facilitate position sensing. In some scenarios, the mobile device 110 may have previously acquired and tracked the positioning signal 141, and relied on it to sense position. Because the positioning signal 141 is now blocked, the positioning signal 141 is lost. The mobile device 110 may need to replace or re-acquire the positioning signal 141 before the position of the mobile device 110 can be accurately sensed.

Additionally or alternatively, the positioning signal 141 may be reflected off the one or more intervening structures, resulting in a reflected positioning signal 143. Because the positioning signal 141 reaches the mobile device 110 indirectly, it may not facilitate position sensing. As will be discussed in greater detail below, the mobile device 110 may sense position based on estimated times of flight (TOF) associated with the positioning signals 121, 131, 141. Because the positioning signal 141 is reflected and received as the reflected positioning signal 143, the path of the positioning signal 141 is lengthened. Accordingly, the TOF estimated by the mobile device 110 may also be lengthened. As a result, the reflected positioning signal 143 received by the mobile device 110 may cause an inaccurate estimation of the distance between the transmitting device 140 and the mobile device 110. The position sensing capability of the 110 may therefore be degraded.

It will be understood that in some scenarios, a direct line of sight to the transmitting devices 120, 130, 140 may not be reliably obtained. Accordingly, if one or more terrestrial networks associated with the mobile device 110 requests a location report, the mobile device 110 may not be able to perform accurate measurements. As a result, the efficiency of the one or more terrestrial networks may be reduced.

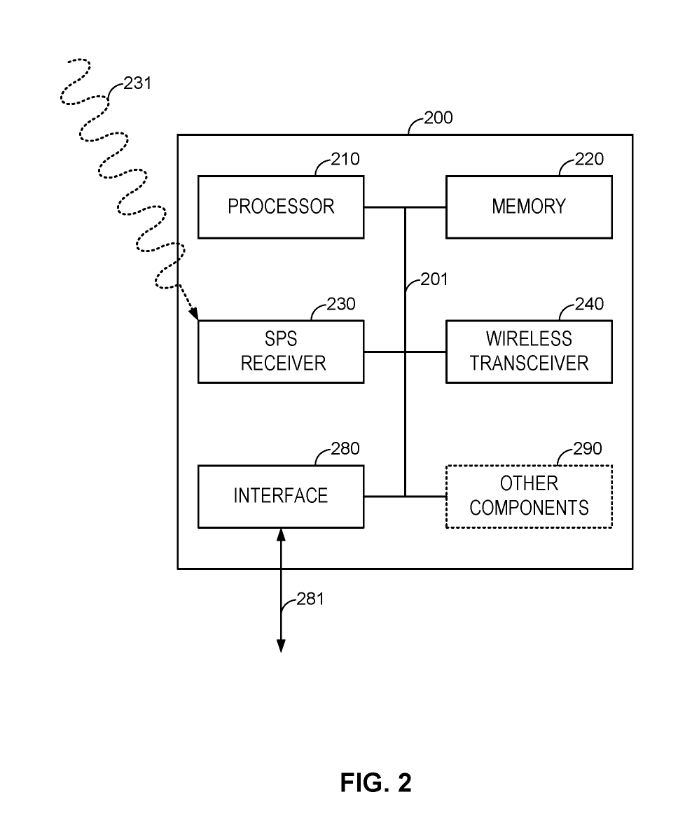

FIG. 2 generally illustrates a mobile device 200 having position sensing capabilities. The mobile device 200 depicted in FIG. 2 includes a processor 210, a memory 220, a SPS receiver 230, a wireless transceiver 240, and an interface 280. The mobile device 200 may optionally include other components 290.

The processor 210 may include one or more microprocessors, microcontrollers, and/or digital signal processors that provide processing functions, as well as other calculation and control functionality. The memory 220 may be configured to store data and/or instructions for executing programmed functionality within the mobile device 200. The memory 220 may include on-board memory that is, for example, in a same integrated circuit package as the processor 210. Additionally or alternatively, memory 220 may be external to the processor 210 and functionally coupled over the common bus 201.

The SPS receiver 230 may be configured to receive one or more positioning signals 231 from a transmitting device, for example, a transmitting device analogous to the transmitting devices 120, 130, 140 depicted in FIG. 1. The SPS receiver 230 may be further configured to estimate range measurements based on the one or more positioning signals 231. The range measurements estimated by the SPS receiver 230 may indicate a distance between the mobile device 200 and the particular transmitting device from which a particular positioning signal of the one or more positioning signals 231 was received. The SPS receiver 230 may be configured to receive the one or more positioning signals 231 using, for example, one or more antennas, one or more filters, one or more demodulators, a receiver clock, and/or any other suitable hardware.

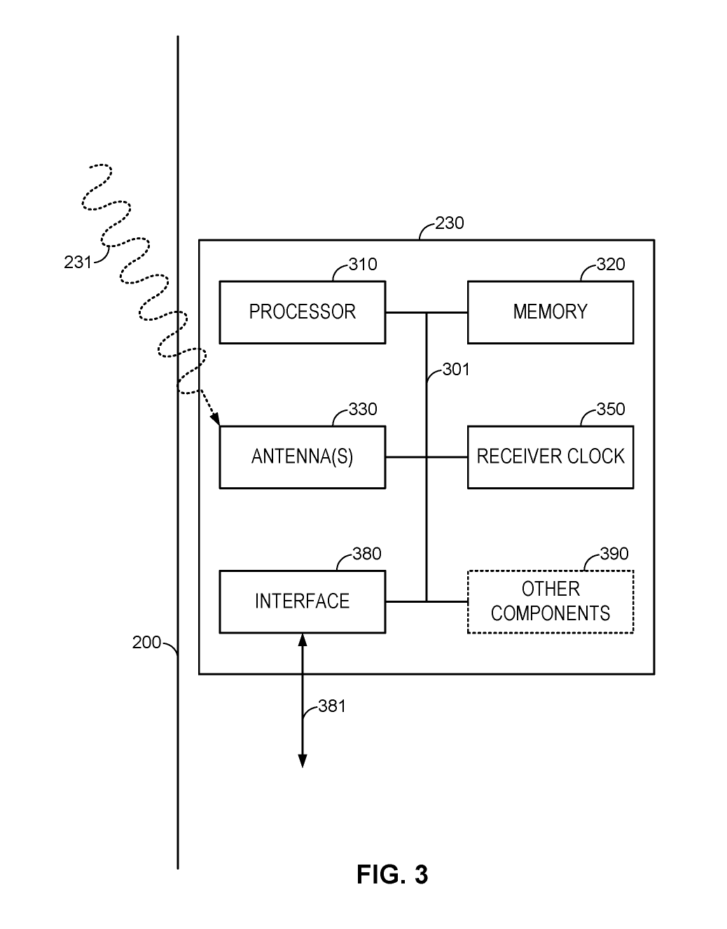

The SPS receiver 230 may further comprise any suitable hardware and/or software for receiving, processing, and/or storing the received positioning signals, as will be discussed in greater detail below by reference to FIG. 3. In some implementations, the SPS receiver 230 may comprise a processor and a memory that are analogous in some respects to the processor 210 and the memory 220 described above. The SPS receiver 230 may be configured to generate SPS-based location data using the one or more positioning signals 231 and to provide the SPS-based location data to one or more components of the mobile device 200.

The wireless transceiver 240 may be configured to send and receive various signals in accordance with one or more terrestrial networks, for example, an LTE network, a UMB network, an EV-DO network, an 802.11 network, etc. The wireless transceiver 240 may be configured to receive report requests from the one or more terrestrial networks, for example, MDT measurement requests (wherein the abbreviation MDT stands for Minimization of Drive Test). In response to a received MDT measurement request, the mobile device 200 may be configured to generate location data and report the generated location data to a location server.

The location server may be associated with one or more of the one or more terrestrial networks. The wireless transceiver 240 may be further configured to transmit the requested report, including the location data, to the location server. As noted above, the location data may include SPS-based location data generated by the mobile device 200 using the SPS receiver 230. Additionally or alternatively, the location data may include network-based location data generated by the mobile device 200 using the wireless transceiver 240. In order to generate the network-based location data, the mobile device 200 may be configured to receive network-based location signals, for example, signals associated with an Enhanced Cell ID (E-CID) positioning method, Position Reference Signals (PRS), or any combination thereof. Using the received network-based location signals, the mobile device 200 may be configured to generate the network-based location data.

The interface 280 may be used to provide interface data 281 of the mobile device 200 to an external entity. For example, the interface 280 may comprise a user interface and the interface data 281 may include audio output, visual output, tactile output, or any other output suitable for a user of the mobile device 200 (for example, a screen, a speaker, etc.). Additionally or alternatively, the interface data 281 may include audio input, visual input, tactile input, or any other suitable input from a user of the mobile device 200 (for example, from a microphone, a touch screen, a keyboard, a button, etc.). Additionally or alternatively, the interface 280 may comprise an electrical coupling and the interface data 281 may include one or more signals (for example, a sensed position of the mobile device 200) to another device (for example, an external user interface, a vehicle, etc.). Additionally or alternatively, the interface 280 may comprise a transceiver and the interface data 281 may include one or more transmitted signals (for example, a sensed position of the mobile device 200).

The other components 290 may include, for example, wide area network transceivers, local area network transceivers, or any other components suitable for inclusion in a mobile device such as the mobile device 200. It will be understood that the mobile device 200 may be a music player, a video player, an entertainment unit, a navigation device, a communications device, a mobile device, a mobile phone, a smartphone, a personal digital assistant, a fixed location terminal, a tablet computer, a computer, a wearable device, an Internet of things (IoT) device, a laptop computer, a server, a device in a automotive vehicle, and/or any other device with a need for position sensing capability. As such, the mobile device 200 may include any number of other components 290.

FIG. 3 generally illustrates a detail of the SPS receiver 230 depicted in FIG. 2. The SPS receiver 230 may comprise a processor 310, a memory 320, an antenna 330, a receiver clock 350, an interface 380, and other components 390.

The processor 310 and the memory 320 may be analogous in some respects to the processor 210 and the memory 220 described above. The processor 310 and/or memory 320 may be configured to process and/or store the signals received by the antenna 330. The processor 310 and/or memory 320 may be further configured to generate position data 381 indicating a position of the SPS receiver 230. The position data 381 may be provided by the processor 310 and/or memory 320 to the interface 380. The interface 380 may be used to provide the position data 381 to an external entity, for example, the common bus 201 of the mobile device 200.

The antenna 330 may be configured to receive one or more positioning signals 231. In some implementations, the antenna 330 may include a plurality of antennas, for example, one or more main antennas and/or one or more reference antennas. However, for simplicity of illustration, the one or more antennas included in the SPS receiver 230 will be referred to in the singular as the antenna 330. The one or more positioning signals 231 may be analogous to the positioning signals 121, 131, 141 depicted in FIG. 1 and may be received from transmitting devices analogous to the transmitting devices 120, 130, 140 depicted in FIG. 1. The antenna 330 may be configured to receive the one or more positioning signals 231 continuously over a period of time.

In some implementations, the one or more positioning signals 231 may include a pseudo-random noise (PRN) code. Each transmitting device may be associated with a unique and/or specific code. The memory 320 may store a plurality of replica codes and the identity and/or position of a specific transmitting device to which each of the replica codes corresponds. For example, “CODE₁₂₀” may correspond to the transmitting device 120 depicted in FIG. 1, “CODE₁₃₀” may correspond to the transmitting device 130 depicted in FIG. 1, “CODE₁₄₀” may correspond to the transmitting device 140 depicted in FIG. 1, etc. If, for example, the positioning signal 121 is received at the antenna 330, then the positioning signal 121 may include the “CODE₁₂₀” identifying the transmitting device 120. To recognize the CODE₁₂₀, the SPS receiver 230 may correlate the received positioning signal 121 with one or more of the replica codes CODE₁₂₀, CODE₁₃₀, CODE₁₄₀, etc. The SPS receiver 230 may be configured to determine, based on the correlating, that the positioning signal 121 includes the CODE₁₂₀, a was therefore received from the transmitting device 120. Moreover, the timing of the correlating may be used to estimate the distance from the transmitting device 120 to the SPS receiver 230, as will be discussed in greater detail below.

The receiver clock 350 may be configured to keep time. The receiver clock 350 may be synchronized with a transmitter clock incorporated into the transmitting device 120. In some implementations, each of the transmitting devices 120, 130, 140 may be equipped with a high-precision transmitter clock, for example, an atomic clock. The transmitter clocks in each of the transmitting devices 120, 130, 140 may be synchronized with one another.

The start time t_{T} for the transmission of a particular code may be predetermined and known to, for example, the SPS receiver 230. Moreover, the receiver clock 350 may be configured to determine a time t_{R} at which a particular code, for example, the CODE₁₂₀, is received. Accordingly, the delay t_{TOF} caused by the time of flight of the positioning signal 121 from the transmitting device 120 to the antenna 330 may be determined based on the predetermined transmission time t_{T} and the receiving time t_{R}. In particular, the delay t_{TOF} may be equal to t_{R}−t_{T}.

For example, “CODE₁₂₀” may have a 1.00 ms duration and may be transmitted at 1.00 ms intervals beginning at a transmission start time t₀. Accordingly, “CODE₁₂₀” will be transmitted at a plurality of transmitting times t_{T}, wherein t_{T}=t₀+N*(1.00 ms), N being an integer. As noted above, the transmission start time t₀ may be scheduled or predetermined such that it is known in advance by both the transmitting device 120 and the SPS receiver 230.

The one or more positioning signals 231 may travel from the transmitting device to the antenna 330 at the speed of light and may reach the antenna 330 after a delay t_{TOF} caused by the time of flight. For example, suppose that CODE₁₂₀ is transmitted at a predetermined transmitting time t_{T}=1.00 ms, and that the receiver clock 350 determines that the code is received at receiving time t_{R}=1.20 ms. The SPS receiver 230 may therefore conclude that the delay t_{TOF} is equal to 0.20 ms. Because the speed of light is ˜300 km/ms, a delay t_{TOF} equal to 0.20 ms would indicate a distance of ˜60 km. The estimated distance may be referred to as a “range estimate”, a “pseudorange”, and/or a “code-phase measurement”. It will be understood that this is a simplified description of how the SPS receiver 230 estimates a code-phase measurement, and that other factors affecting the estimating of the code-phase measurement have been omitted for brevity.

As noted above, each transmitting device may be associated with a different PRN code. Accordingly, the SPS receiver 230 may perform a plurality of code-phase measurements based on a plurality positioning signal analogous to the one or more positioning signals 231. Each code-phase measurement may correspond to a different transmitting device. After, for example, three or more code-phase measurements are performed, the position of the SPS receiver 230 can be calculated using triangulation based on the known positions of the three or more corresponding transmitting devices. In some implementations, code-phase measurements may be used to sense a position of the SPS receiver 230 with precision on the order of several meters.

The SPS receiver 230 can achieve greater precision using carrier-phase measurements. As noted above, each of the one or more positioning signals 231 may include a repeating PRN code used for generating code-phase measurements. However, the code cycle may have a first frequency and may be carried on a carrier wave having a second frequency that is significantly greater than the first frequency. Because the frequency of the carrier wave is greater than the frequency of the code cycle, position sensing that is based on carrier-phase measurements may be more precise than position sensing based on code-phase measurements. For example, if the delay t_{TOF} can be determined using the carrier wave, then the SPS receiver 230 may be able to sense position with precision on the order of tens of centimeters.

FIG. 4 generally illustrates a method 400 in accordance with aspects of the disclosure. The method 400 may be performed by the mobile device 200 depicted in FIG. 2 and/or any of the components thereof.

At 410, the method 400 receives a MDT measurement request. The MDT measurement request may be received from, for example, a terrestrial network with which the mobile device 200 is associated. The receiving 410 may be performed by, for example, the wireless transceiver 240 depicted in FIG. 2. Accordingly, the wireless transceiver 240 may constitute means for receiving a MDT measurement request.

At 420, the method 400 generates SPS-based location data using received SPS signals, such as the one or more positioning signals 231. The SPS-based location data may be, for example, first SPS-based location data. The generating 420 may be performed by, for example, the SPS receiver 230. Accordingly, the SPS receiver 230 may constitute means for generating SPS-based location data.

At 430, the method 400 determines whether the SPS-based location data is accurate or not accurate. The accuracy determining 430 may be performed by, for example, the processor 210 and/or the memory 220 depicted in FIG. 2. Accordingly, the processor 210 and/or memory 220 may constitute means for determining whether SPS-based location data is accurate or not accurate. If it is determined that the SPS-based location data is accurate (‘yes’ at block 430), then the method 400 proceeds to 440. If it is determined that the SPS-based location data is not accurate (‘no’ at block 430), then the method 400 proceeds to 450.

The accuracy determining 430 may be performed in any suitable manner In some implementations, the mobile device 200 may count the number of available transmitting devices, (for example, satellites) and determine if the count exceeds a threshold. If the count exceeds the threshold, then the mobile device 200 may determine that the SPS-based location data is accurate. If the count does not exceed the threshold, then the mobile device 200 may determine that the SPS-based location data is not accurate.

In other implementations, the mobile device 200 may estimate a signal characteristic of the SPS signals from the available satellites, for example, signal to noise ratio (SNR) and determine if the SNR values or an average thereof exceed a threshold. If the SNR exceeds the threshold, then the mobile device 200 may determine that the SPS-based location data is accurate. If the SNR does not exceed the threshold, then the mobile device 200 may determine that the SPS-based location data is not accurate.

In other implementations, the mobile device 200 may estimate an SPS fix value and determine if the fix value associated with the generated SPS-based location data exceeds a threshold. If the SPS fix value does not exceed the threshold, then the mobile device 200 may determine that the SPS-based location data is accurate. If the SPS fix value does exceed the threshold, then the mobile device 200 may determine that the SPS-based location data is not accurate.

In other implementations, the mobile device 200 may estimate dilution of precision values and determine if the dilution of precision estimate exceeds a threshold. If the dilution of precision estimate does not exceed the threshold, then the mobile device 200 may determine that the SPS-based location data is accurate. If the dilution of precision estimate does exceed the threshold, then the mobile device 200 may determine that the SPS-based location data is not accurate. Dilution of precision is a relation between a change in measured data versus a change in output location. In geometric dilution of precision (GDOP) techniques, satellites in divergent areas of the sky offer comparatively more precise results and less dilution of precision than satellites that are clustered more closely together. Other techniques such as horizontal dilution of precision (HDOP), vertical dilution of precision (DOP), position dilution of precision (PDOP) and time dilution of precision (TDOP) are available.

The accuracy determining 430 (which implies SPS-based location data generation 420) may be repeated such that the accuracy determining 430 is performed multiple times (not shown in FIG. 4). In each of the multiple times, the mobile device 200 may generate network-based location data responsive to the determination that the SPS-based location data is not accurate or include the SPS-based location data responsive to the determination that the SPS-based location data is accurate.

Alternatively, the mobile device 200 may only proceed to 450 in response to multiple determinations that the SPS-based location data is not accurate, for example, multiple consecutive determinations. As an example, the mobile device 200 may not proceed to 450 until the generating 420 has been performed X number of times and/or determined at 430 to be inaccurate X number of times.

At 440, the method 400 transmits accurate location data to a location server. The transmitting 440 may be performed by, for example, the wireless transceiver 240 depicted in FIG. 2. The accurate location data may be included in an MDT report that may be responsive to the MDT measurement request received at 410. The wireless transceiver 240 may perform the transmitting 440 in response to an instruction received from the processor 210. The transmitting 440 may include transmitting of an MDT report. Accordingly, the wireless transceiver 240 may constitute means for transmitting accurate location data to a location server.

A conventional MDT report may include data such as a timestamp and location information. The location information may be provided as, for example, an octet identifying a set of coordinates, for example, an ellipsoid point and/or altitude. The conventional MDT report may further include a horizontal velocity. However, if a fix for the SPS-based location data is not available, the location information provided in the MDT report may be empty or null.

An MDT report in accordance with aspects of the disclosure, for example, an MDT report being transmitted at 440, may include location data even if a fix for the SPS-based location data is not available. For example, the MDT report transmitted at 440 may include a timestamp and, for example, an enhanced cell identifier (E-CID) measurement result and/or a transmission/reception time difference result.

At 450, the method 400 powers down the SPS receiver. For example, the mobile device 200 may terminate the generating 420 described above. The powering down 450 may be performed by, for example, the processor 210 and/or memory 220 depicted in FIG. 2. Accordingly, the processor 210 and/or memory 220 may constitute means for powering down the SPS receiver.

At 452, the method 400 starts a backoff timer. The backoff timer may begin at a backoff timer start value. The backoff timer value may indicate the length of a period during which the mobile device 200 generates network-based location data, as will be discussed in greater detail below. If no backoff timer value has been set, then a default backoff timer start value maybe set. The starting 452 may be performed by, for example, the processor 210 and/or the memory 220 depicted in FIG. 2. Accordingly, the processor 210 and/or the memory 220 may constitute means for starting a backoff timer.

At 460, the method 400 generates network-based location data. The generating 460 may be performed by, for example, the wireless transceiver 240 depicted in FIG. 2. The wireless transceiver 240 may perform the generating 460 in response to an instruction received from the processor 210. Accordingly, the wireless transceiver 240 may constitute means for generating network-based location data.

At 470, the method 400 determines if the network-based location data generated at 460 is accurate or not accurate. The accuracy determining 470 may be performed by, for example, the processor 210 and/or the memory 220 depicted in FIG. 2. Accordingly, the processor 210 and/or memory 220 may constitute means for determining whether the network-based location data generated at 460 is accurate or not accurate. If it is determined that the network-based location data is accurate (‘yes’ at block 470), then the method 400 proceeds to 440, described above. If it is determined that the network-based location data is not accurate (‘no’ at block 470), then the method 400 proceeds to 480.

At 480, the method 400 determines if the backoff timer has expired. The timer expiration determining 480 may be performed by, for example, the processor 210 and/or the memory 220 depicted in FIG. 2. Accordingly, the processor 210 and the memory 220 may constitute means for determining if the backoff timer has expired. If it is determined that the backoff timer has expired (‘yes’ at block 480), then the method 400 proceeds to 490. If it determined that the backoff timer has not expired (‘no’ at block 480), then the method 400 returns to the generating 460.

At 490, the method 400 increment the backoff timer value. The incrementing 490 may be performed by, for example, the processor 210 and/or the memory 220 depicted in FIG. 2. Accordingly, the processor 210 and/or the memory 220 may constitute means for incrementing the backoff timer value. After the incrementing 490 is complete, the method 400 may return to the generating 420 of the SPS-based location data. The generating 420 performed after the incrementing 490 may be generating of second SPS-based location data. It will be understood that during the period demarcated by the backoff timer, the mobile device 200 has not been generating or attempting to generate SPS-based location data. Accordingly, resources have been conserved, for example, a battery power of the mobile device 200. It will be further understood that a second attempt to generate reattempted SPS-based location data will be performed after the period demarcated by the backoff timer, and that a second failed attempt will result in an incremented period, a third failed attempt will result in a further incremented period, etc. As a result, the amount of resources conserved may increase in proportion to the number of failed attempts. The amount of the increment may be, for example, a set time unit. Alternatively, the increment may be selected such that the backoff timer value increases by a set percentage.

FIG. 5 generally illustrates another method 500 in accordance with aspects of the disclosure. The method 500 may be performed by the mobile device 200 depicted in FIG. 2 and/or any of the components thereof.

At 510, the method 500 receives a MDT measurement request. The MDT measurement request may be received from, for example, a terrestrial network with which the mobile device 200 is associated. The receiving 510 may be performed by, for example, the wireless transceiver 240 depicted in FIG. 2. Accordingly, the wireless transceiver 240 may constitute means for receiving a MDT measurement request.

At 520, the method 500 determines whether to generate SPS-based location data. The determination may be based on one or more accuracy factors, for example, one or more previously-recorded accuracy factors analogous to the accuracy factors described in greater detail below (block 570). If it is determined not to generate SPS-based location data (‘no’ at block 520), then the method 500 proceeds to 530. If it is determined to generate SPS-based location data (‘yes’ at block 520), then the method 500 proceeds to 540. The determining 520 may be performed by, for example, the processor 210 and/or the memory 220 depicted in FIG. 2. Accordingly, the processor 210 and/or the memory 220 may constitute means for determining whether to generate SPS-based location data.

At 530, the method 500 ends. By ending the method 500 prior to generation of SPS-based location data, the mobile device 200 may be able to conserve resources, as will be discussed in greater detail below.

At 540, the method 500 generates SPS-based location data. The generating 540 may be performed by, for example, the SPS receiver 230 depicted in FIG. 2. Accordingly, the SPS receiver 230 may constitute means for generating SPS-based location data.

At 550, the method 500 determines if the SPS-based location data is accurate. The determining 550 may be performed by, for example, the processor 210 and/or the memory 220 depicted in FIG. 2. Accordingly, the processor 210 and/or memory 220 may constitute means for determining if the SPS-based location data is accurate. If it is determined that the SPS-based location data is accurate (‘yes’ at block 520), then the method 500 proceeds to 560. If it is determined that the SPS-based location data is inaccurate (‘no’ at block 520), then the method 500 proceeds to 570.

At 560, the method 500 transmits accurate location data to a location server. The transmitting 560 may be performed by, for example, the wireless transceiver 240 depicted in FIG. 2. Accordingly, the wireless transceiver 240 may constitute means for transmitting accurate location data to a location server.

At 570, the method 500 records accuracy factor data. The recording 570 may be performed by, for example, the processor 210 and/or the memory 220 depicted in FIG. 2. Accordingly, the processor 210 and/or the memory 220 may constitute means for recording accuracy factor data.

The one or more accuracy factors may include, for example, an accuracy value associated with the SPS-based location data, a distance from a particular wireless access point at the time of the generating of the first SPS-based location data, a density of wireless access points in a surrounding area at the time of the generating of the first SPS-based location data, geofence data associated with the surrounding area at the time of the generating of the first SPS-based location data, or any combination thereof. By recording the one or more accuracy factors over time, the mobile device 200 may be able to identify a correlation between the accuracy of the SPS-based location data and the one or more accuracy factors.

In some implementations, the distance from a particular wireless access point (for example, a familiar private Wi-Fi router) may correlate with inaccurate SPS signals. For example, the processor 210 and/or memory 220 may determine that at times when the particular wireless access point is in range of the mobile device 200, SPS signals are inaccurate. This may be because, for example, the wireless access point is located deep indoors. The processor 210 and/or memory 220 may record data resulting from the accuracy determining 550 and may further record whether a certain access point is present (and/or a distance thereto) at the time that the SPS-based location data was generated. It will be understood that over time, the processor 210 and/or memory 220 may be configured to detect a correlation between the presence/absence of a particular access point and the accuracy/inaccuracy of SPS range estimates. Once the correlation is established, the mobile device 200 may infer that the SPS range estimates are inaccurate based on detection of the presence of the particular access point.

Geofence data, which indicates that the mobile device 200 is within a certain area (based on, for example, radio frequency identification (RFID) technology), may be used in the same manner Over time, the processor 210 and/or memory 220 may be configured to detect a correlation between a particular geofenced location and the accuracy/inaccuracy of SPS range estimates. Once the correlation is established, the mobile device 200 may infer that the SPS range estimates are inaccurate based on detection of the presence of the particular geofenced location.

The density of wireless access points may also correlate with inaccurate SPS signals. For example, an office building might have a dozen access points, all of which may be in range of the mobile device 200 at a particular time. The mobile device 200 may infer that the SPS range estimates are unlikely to be accurate based on the simultaneous detection of a certain number of wireless access points.

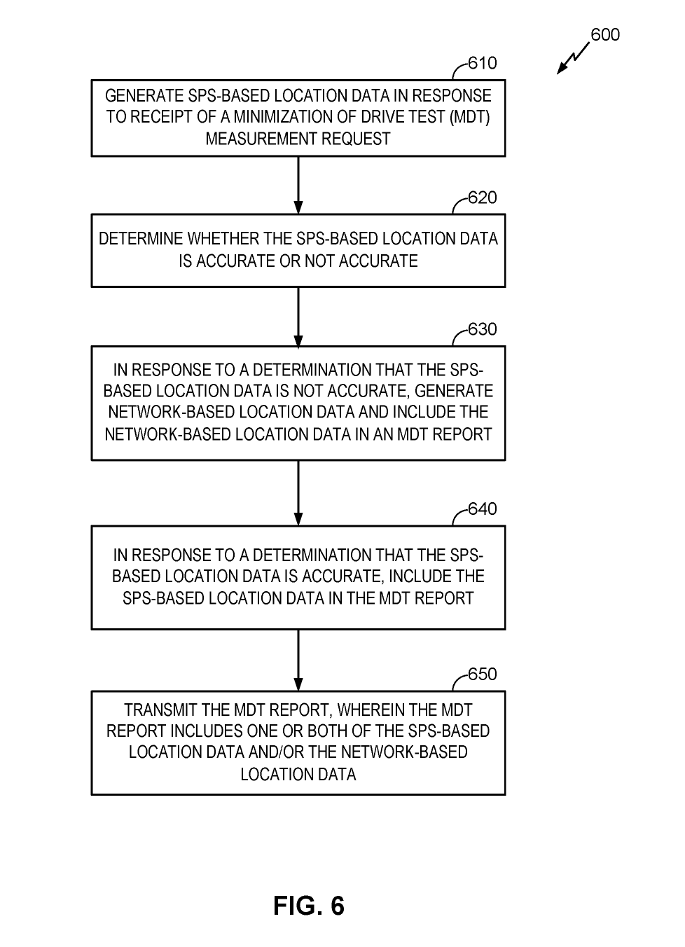

FIG. 6 generally illustrates a method 600 in accordance with aspects of the disclosure.

At 610, the method 600 generates SPS-based location data using the SPS receiver in response to receipt of a minimization of drive test (MDT) measurement request. The generating 610 may be performed by, for example, the SPS receiver 230 depicted in FIG. 2.

At 620, the method 600 determines whether the SPS-based location data generated at 610 is accurate or not accurate. The determining 620 may be performed by, for example, the processor 210 and/or memory 220 depicted in FIG. 2.

At 630, the method 600 generates network-based location data using the wireless transceiver and include the network-based location data in an MDT report in response to a determination that the SPS-based location data is not accurate. The generating 630 may be performed by, for example, the processor 210 and/or memory 220 depicted in FIG. 2.

At 640, the method 600 includes the SPS-based location data in the MDT report in response to a determination that the SPS-based location data is accurate. The including 640 may be performed by, for example, the processor 210 and/or memory 220 depicted in FIG. 2.

At 650, the method 600 transmits the MDT report, wherein the MDT report includes one or both of the SPS-based location data and/or the network-based location data. The transmitting 650 may be performed by, for example, the wireless transceiver 240 depicted in FIG. 2.

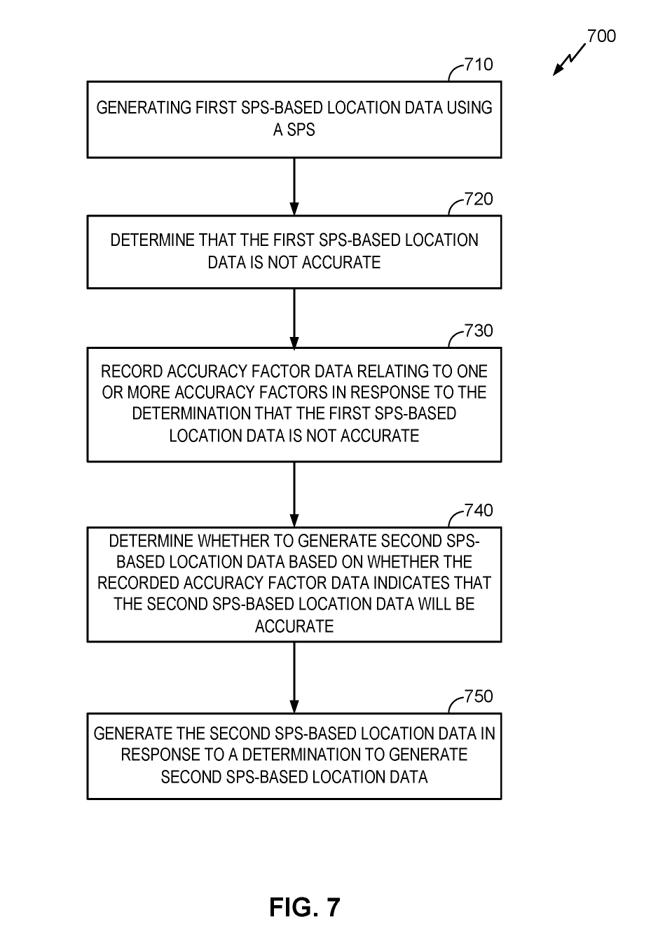

FIG. 7 generally illustrates another method 700 in accordance with aspects of the disclosure.

At 710, the method 700 generates first SPS-based location data using a satellite positioning service (SPS). The generating 710 may be performed by, for example, the SPS receiver 230 depicted in FIG. 2.

At 720, the method 700 determines that the first SPS-based location data is not accurate. The determining 720 may be performed by, for example, the processor 210 and/or memory 220 depicted in FIG. 2.

At 730, the method 700 records accuracy factor data relating to one or more accuracy factors in response to the determination that the first SPS-based location data is not accurate. The recording 730 may be performed by, for example, the processor 210 and/or memory 220 depicted in FIG. 2.

At 740, the method 700 determines whether to generate second SPS-based location data based on whether the recorded accuracy factor data indicates that the second SPS-based location data will be accurate. The determining 740 may be performed by, for example, the processor 210 and/or memory 220 depicted in FIG. 2.

At 750, the method 700 generates the second SPS-based location data in response to a determination to generate second SPS-based location data. The generating 750 may be performed by, for example, the wireless transceiver 240 depicted in FIG. 2.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted to depart from the scope of the present disclosure.

The various illustrative logical blocks, modules, and circuits described in connection with the aspects disclosed herein may be implemented or performed with a general purpose processor, a digital signal processor (DSP), an ASIC, an field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The methods, sequences and/or algorithms described in connection with the aspects disclosed herein may be embodied directly in hardware, in a software module executed by a processor, or in a combination of the two. A software module may reside in RAM, flash memory, ROM, EPROM, EEPROM, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in an IoT device. In the alternative, the processor and the storage medium may reside as discrete components in a user terminal.

In one or more exemplary aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, DSL, or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes CD, laser disc, optical disc, DVD, floppy disk and Blu-ray disc where disks usually reproduce data magnetically and/or optically with lasers. Combinations of the above should also be included within the scope of computer-readable media.

While the foregoing disclosure shows illustrative aspects of the disclosure, it should be noted that various changes and modifications could be made herein without departing from the scope of the disclosure as defined by the appended claims. The functions, steps and/or actions of the method claims in accordance with the aspects of the disclosure described herein need not be performed in any particular order. Furthermore, although elements of the disclosure may be described or claimed in the singular, the plural is contemplated unless limitation to the singular is explicitly stated.

1. An apparatus, the apparatus comprising:
a wireless transceiver configured to transmit and receive wireless signals;
a satellite positioning service (SPS) receiver configured to receive SPS signals;
memory; and
a processor coupled to the wireless transceiver, the SPS receiver, and the memory, wherein one or more of the processor and the memory are configured to:
generate SPS-based location data using the SPS receiver in response to receipt of a minimization of drive test (MDT) measurement request;
determine whether the SPS-based location data is accurate or not accurate wherein to determine whether the SPS-based location data is accurate or not accurate, one or more of the processor and the memory is configured to estimate the accuracy based on one or more of:
a count of a number of available transmitting devices from which the SPS signals are received;
a signal characteristic of the SPS signals; and
a dilution of precision estimate;
in response to a determination that the SPS-based location data is not accurate, generate network-based location data using the wireless transceiver and include the network-based location data in an MDT report;
in response to a determination that the SPS-based location data is accurate, include the SPS-based location data in the MDT report; and
transmit the MDT report, wherein the MDT report includes one or both of the SPS-based location data and/or the network-based location data.

2. The apparatus of claim 1, wherein the one or more of the processor and the memory is further configured to:
repeat the generating of the SPS-based location data and the determining of whether the SPS-based location data is accurate or not accurate multiple times in response to the receipt of the MDT measurement request, wherein:
in each of the multiple times, the one or more of the processor and the memory are further configured to generate network-based location data responsive to the determination that the SPS-based location data is not accurate or include the SPS-based location data responsive to the determination that the SPS-based location data is accurate.

3. The apparatus of claim 1, wherein one or more of the processor and the memory is further configured to:
in response to the determination that the SPS-based location data is not accurate, power down the SPS receiver.

4. The apparatus of claim 1, wherein one or more of the processor and the memory is further configured to:
in response to the determination that the SPS-based location data is not accurate, start a backoff timer associated with a backoff timer start value before including the network-based location data in the MDT report.

5. The apparatus of claim 4, wherein one or more of the processor and the memory is further configured to:
determine whether the backoff timer has expired;
determine whether the network-based location data is accurate or not accurate; or
any combination thereof.

6. The apparatus of claim 5, wherein:
the one or more of the processor and the memory are further configured to:
include the network-based location data in the MDT report in response to a determination that the network-based location data is accurate.

7. The apparatus of claim 5, wherein one or more of the processor and the memory is further configured to:
in response to determinations that the backoff timer has expired and that the network-based location data is not accurate, generate reattempted SPS-based location data using the SPS receiver.

8. The apparatus of claim 7, wherein one or more of the processor and the memory are further configured to:
in response to a determination that the reattempted SPS-based location data is accurate, include the reattempted SPS-based location data in the MDT report; and
in response to a determination that the reattempted SPS-based location data is not accurate, increment the backoff timer value.

9. The apparatus of claim 1, wherein the wireless signals received by the wireless transceiver are:
Enhanced Cell ID positioning service (E-CID) signals;
Position Reference Signals (PRS); or
any combination thereof.

10. The apparatus of claim 1, wherein to determine that the SPS-based location data is accurate or not accurate, one or more of the processor and the memory is further configured to estimate the accuracy based on:
whether a fix value associated with the generated SPS-based location data exceeds a threshold.

11. A method, the method comprising:
generating satellite positioning service (SPS) based location data using a SPS receiver in response to receipt of a minimization of drive test (MDT) measurement request;
determining that the SPS-based location data is not accurate, wherein the determining comprising estimating the accuracy based on one or more of:
a count of a number of available transmitting devices from which the SPS signals are received;
a signal characteristic of the SPS signals; and
a dilution of precision estimate;
in response to the determination that the SPS-based location data is not accurate, generating network-based location data using a wireless transceiver and including the network-based location data in an MDT report;
in response to a determination that the SPS-based location data is accurate, including the SPS-based location data in the MDT report; and
transmitting the MDT report, wherein the MDT report includes one or both of the SPS-based location data and/or the network-based location data.

12. The method of claim 11, further comprising:
receiving a minimization of drive test (MDT) measurement request; and
generating the SPS-based location data in response to the receiving of the MDT measurement request.

13. The method of claim 11, further comprising:
in response to the determination that the SPS-based location data is not accurate, powering down the SPS receiver.

14. The method of claim 11, further comprising:
in response to the determination that the SPS-based location data is not accurate, starting a backoff timer associated with a backoff timer start value.

15. The method of claim 14, further comprising:
determining whether the network-based location data is accurate or not accurate;
determining whether the backoff timer has expired; or
any combination thereof.

16. The method of claim 15, further comprising:
in response to a determination that the network-based location data is accurate, including the network-based location data in the MDT report.

17. The method of claim 15, further comprising:
in response to determinations that the backoff timer has expired and that the network-based location data is not accurate, incrementing the backoff timer value.

18. The method of claim 15, further comprising:
in response to determinations that the backoff timer has expired and that the network-based location data is not accurate, generating second SPS-based location data using the SPS receiver.

19. The method of claim 11, wherein generating the network-based location data using the wireless transceiver comprises receiving wireless signals, the wireless signals comprising:
Enhanced Cell ID positioning service (E-CID) signals;
Position Reference Signals (PRS); or
any combination thereof.

20. The method of claim 11, wherein determining that the SPS-based location data is not accurate comprises estimating the accuracy further based on
whether a fix value associated with the generated SPS-based location data exceeds a threshold.

21. An apparatus, the apparatus comprising:
a wireless transceiver configured to transmit and receive wireless signals;
a satellite positioning service (SPS) receiver configured to receive SPS signals;
memory; and
a processor coupled to the wireless transceiver, the SPS receiver, and the memory, wherein one or more of the processor and the memory is configured to:
generate first SPS-based location data using the received SPS signals;
determine that the first SPS-based location data is not accurate;
in response to the determination that the first SPS-based location data is not accurate, record accuracy factor data relating to one or more accuracy factors wherein the one or more accuracy factors include:
a distance from a particular wireless access point at the time of the generating of the first SPS-based location data;
geofence data associated with the surrounding area at the time of the generating of the first SPS-based location data; or
any combination thereof;
determine whether to generate second SPS-based location data based on whether the recorded accuracy factor data indicates that the second SPS-based location data will be accurate; and
in response to a determination to generate second SPS-based location data, generate the second SPS-based location data.

22. The apparatus of claim 21, wherein:
the wireless transceiver is further configured to receive a minimization of drive test (MDT) measurement request; and
one or more of the processor and the memory are configured to generate the SPS-based location data in response to the receiving of the MDT measurement request.

23. The apparatus of claim 21, wherein:
the wireless transceiver is further configured to transmit the second SPS based location data to a location server; and
one or more of the processor and the memory are configured to:
in response to a determination that the network-based location data is accurate, include the network-based location data in the MDT report.

24. The apparatus of claim 21, wherein the one or more accuracy factors further include
a density of wireless access points in a surrounding area at the time of the generating of the first SPS-based location data.

25. The apparatus of claim 21, wherein one or more of the processor and the memory is configured to:
in response to a determination not to generate second SPS-based location data, terminate the generating of SPS-based location data.

26. A method, the method comprising:
generating first satellite positioning service (SPS-based location data;
determining that the first SPS-based location data is not accurate;
in response to the determination that the first SPS-based location data is not accurate, recording accuracy factor data relating to one or more accuracy factors, wherein the one or more accuracy factors include:
a distance from a particular wireless access point at the time of the generating of the first SPS-based location data;
geofence data associated with the surrounding area at the time of the generating of the first SPS-based location data; or
any combination thereof; and
determining whether to generate second SPS-based location data based on whether the recorded accuracy factor data indicates that the second SPS-based location data will be accurate;
in response to a determination to generate second SPS-based location data, generating the second SPS-based location data.

27. The method of claim 26, further comprising:
receiving a minimization of drive test (MDT) measurement request; and
generating the SPS-based location data in response to the receiving of the MDT measurement request.

28. The method of claim 26, further comprising:
in response to a determination that the network-based location data is accurate, include the network-based location data in the MDT report.

29. The method of claim 26, wherein the one or more accuracy factors further include
a density of wireless access points in a surrounding area at the time of the generating of the first SPS-based location data.

30. The method of claim 26, further comprising:
in response to a determination not to generate second SPS-based location data, terminating the generating of SPS-based location data.
